(19) United States
(12) Patent Application Publication
(10) Pub. No.: US 2025/0156892 A1
(43) Pub. Date: May 15, 2025

(54) MONITORING USERS TO PROVIDE INCENTIVES ON A DECENTRALIZED NETWORK

(71) Applicant: DISH Wireless L.L.C., Englewood, CO (US)

(72) Inventors: Owen Christens-Barry, Castle Rock, CO (US); Robert Urbanek, Englewood, CO (US)

(21) Appl. No.: 19/003,789

(22) Filed: Dec. 27, 2024

Related U.S. Application Data
(62) Division of application No. 18/465,358, filed on Sep. 12, 2023.

(51) Int. Cl. G06Q 30/0214; G06F 16/27; G06N 5/022; G06Q 30/0207; G06Q 30/0226

(52) U.S. Cl. CPC G06Q 30/0214; G06F 16/27; G06N 5/022; G06Q 30/0213; G06Q 30/0215; G06Q 30/0224; G06Q 30/0226; G06Q 30/0236

(57) ABSTRACT

The present disclosure is directed to methods and systems for monitoring users on a decentralized network. The system can track users on the decentralized network to identify the products or services the users have purchased or have a subscription to. The system can identify whether a user has referred other users to purchase or subscribe to a product or service and provide an incentive to the user if a referral was made. By storing user data in a decentralized network, the system can determine the size of a social network of a user and the duration that a user maintains a product or service. In some implementations, the user data is arranged into a hierarchy to provide a visual representation of the social connections and products of the user.

### CROSS REFERENCE TO RELATED APPLICATIONS

This application is a divisional of U.S. patent application Ser. No. 18/465,358, filed Sep. 12, 2023, entitled “MONITORING USERS TO PROVIDE INCENTIVES ON A DECENTRALIZED NETWORK,” the entire disclosure of each of which is incorporated herein by reference.

### BACKGROUND

Family plans for products or services are difficult to track. Sometimes strangers are grouped together to receive the discounts of a family plan, however there is no method to encourage loyalty among the strangers to remain in the plan other than a discount. Additionally, there is no current method to track whether a salesmen recruited customers that have the potential to be long lasting or a quick turnover.

It is with respect to these and other general considerations that the aspects disclosed herein have been made. Also, although relatively specific problems may be discussed, it should be understood that the examples should not be limited to solving the specific problems identified in the background or elsewhere in the disclosure.

### BRIEF DESCRIPTION OF THE DRAWINGS

Non-limiting and non-exhaustive examples are described with reference to the following figures.

FIG. 1 illustrates an example of distributed system for monitoring users on a decentralized network.

FIG. 2 illustrates an example input processing system for implementing systems and methods for monitoring users on a decentralized network.

FIG. 3 is a flow diagram illustrating a process used in some implementations for monitoring a user on a decentralized network.

FIG. 4 is a flow diagram illustrating a process used in some implementations for monitoring a product distributer on a decentralized network.

FIG. 5 is a flow diagram illustrating a process used in some implementations for generating a data hierarchy associated with a user.

FIG. 6 is a conceptual diagram depicting the organization of multiple customers into a customer hierarchy.

FIG. 7 is a conceptual diagram depicting browsing customers via a customer hierarchy and based on user search criteria.

FIG. 8 illustrates one example of a suitable operating environment in which one or more of the present embodiments may be implemented.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to methods and systems for monitoring users on a decentralized network. The system can track users (e.g., customers, subscribers, salesmen, etc.) on the decentralized network (e.g., blockchain network) to identify the products or services the users have purchased or have a subscription to. The system can identify whether a user has referred other users to purchase or subscribe to a product or service and provide an incentive to the user if a referral was made. By storing user data in a decentralized network, the system can determine the size of a social network of a user and the duration that a user maintains a product or service. In some implementations, the user data is arranged into a hierarchy to provide a visual representation of the social connections and products of the user. By storing the customer information on a decentralized network, the system can track a user across any number of companies, products, or services, due to the network not being limited to a single product provider. For example, the system can determine whether a customer is loyal to a product or service but switched companies due to receive a cheaper price.

Methods and systems disclosed herein can provide technical advantages over conventional systems. The disclosed system provides: 1) increased security for personal data by storing it on a blockchain network; 2) transparency of user data to identify users to reward; 3) accuracy in identifying customers that are loyal to products or services across multiple companies; 4) a method to identify characteristics of customers that result in loyalty to a company; and 5) identify fraud of employees that group unrelated customers into plans.

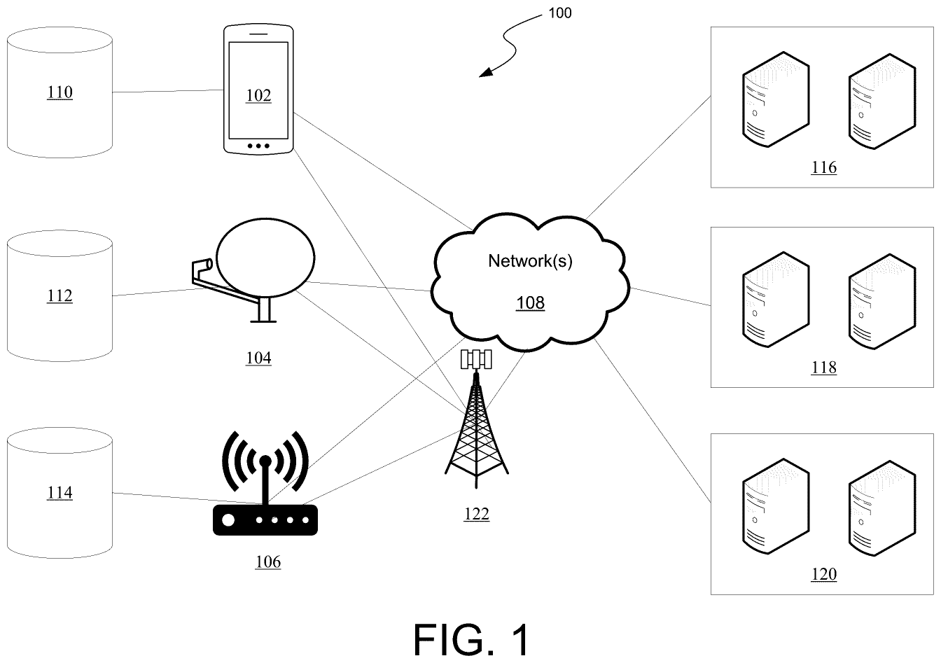

FIG. 1 illustrates an example of a system for monitoring users on a decentralized network. Example system 100 presented is a combination of interdependent components that interact to form an integrated whole of a wireless network. Components of the systems may be hardware components or software implemented on, and/or executed by, hardware components of the systems. For example, system 100 comprises client devices 102, 104, and 106, local databases 110, 112, and 114, network(s) 108, and server devices 116, 118, and/or 120.

Client devices 102, 104, and 106 may be configured to monitor a user on a decentralized network and track the products or services associated with the user. In one example, a client device 102 may be a mobile phone, a client device 104 may be a smart OTA antenna, and a client device 106 may be a broadcast module box (e.g., set-top box). In other example aspects, client device 106 may be a gateway device that is in communication with other gateway devices and multimedia content providers. Other possible client devices include but are not limited to tablets, personal computers, televisions, etc. In aspects, a client device, such as client devices 102, 104, and 106, may be equipped to access and/or locally store information (e.g., ledgers, private/public keys, etc.) associated with a blockchain network. In other aspects, a client device, such as client devices 102, 104, and 106, may access a product or service. Client devices 102, 104, and 106, may be equipped to monitor the activity (e.g., subscriptions to products or services, referring other users subscribe to a product or service, etc.) of a user. The signals that client devices 102, 104, and 106 may receive may be transmitted from satellite broadcast tower 122 and/or network(s) 108. Broadcast tower 122 (e.g., base station, gNB, etc.) may also be configured to communicate with network(s) 108, in addition to being able to communicate directly with client devices 102, 104, and 106. In some examples, a client device may be a set-top box that is connected to a display device, such as a television (or a television that may have set-top box circuitry built into the television mainframe).

In some example aspects, client devices 102, 104, and/or 106 may be equipped to receive signals from an input device. Signals may be received on client devices 102, 104, and/or 106 via Bluetooth, Wi-Fi, infrared, light signals, binary, among other mediums and protocols for transmitting/receiving signals. For example, a user may use a mobile device 102 to check for the media content data from a channel from an OTA antenna (e.g., antenna 104). A graphical user interface may display on the mobile device 102 indicating the media content search results of certain local channels. Specifically, at a particular geolocation, the antenna 104 may receive signals from broadcast tower 122. The antenna 104 may then transmit those signals for analysis via network(s) 108. The results of the analysis may then be displayed on mobile device 102 via network(s) 108. In other examples, the results of the analysis may be displayed on a television device connected to a broadcast module box, such as broadcast module box 106. In some examples client devices 102, 104, and 106 may each have a local information (e.g., ledgers, private/public keys, etc.) of the blockchain network stored in local databases 110, 112, and/or 114. In other example aspects, the client devices 102, 104, and 106 may access a remotely-stored information via network(s), wherein the information may be stored on remote server(s) 116, 118, and/or 120.

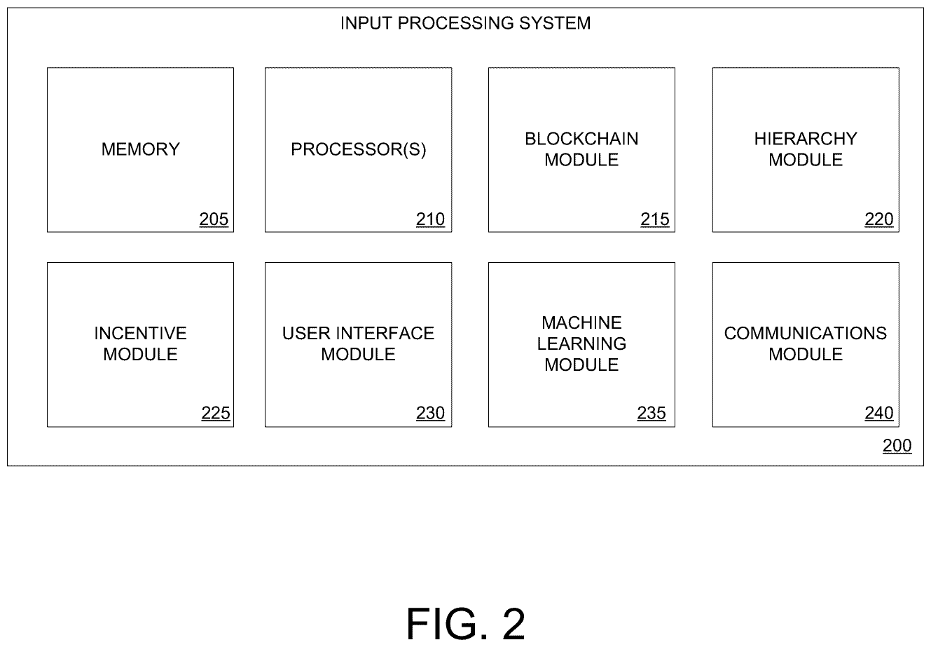

FIG. 2 illustrates an example input processing system for implementing systems and methods for monitoring a user on a decentralized network. The input processing system (e.g., one or more data processors) is capable of executing algorithms, software routines, and/or instructions based on processing data provided by a variety of sources related to monitoring users on a decentralized network. The input processing system 200 can be a general-purpose computer or a dedicated, special-purpose computer. According to the embodiments shown in FIG. 2, the disclosed system can include memory 205, one or more processors 210, blockchain module 215, hierarchy module 220, incentive module 225, user interface module 230, machine learning module 235, and communications module 240. Other embodiments of the present technology may include some, all, or none of these modules and components, along with other modules, applications, data, and/or components. Still yet, some embodiments may incorporate two or more of these modules and components into a single module and/or associate a portion of the functionality of one or more of these modules with a different module.

Memory 205 can store instructions for running one or more applications or modules on processor(s) 210. For example, memory 205 could be used in one or more embodiments to house all or some of the instructions needed to execute the functionality of blockchain module 215, hierarchy module 220, incentive module 225, user interface module 230, machine learning module 235, and communications module 240. Generally, memory 205 can include any device, mechanism, or populated data structure used for storing information. In accordance with some embodiments of the present disclosures, memory 205 can encompass, but is not limited to, any type of volatile memory, nonvolatile memory, and dynamic memory. For example, memory 205 can be random access memory, memory storage devices, optical memory devices, magnetic media, floppy disks, magnetic tapes, hard drives, SIMMs, SDRAM, RDRAM, DDR, RAM, SODIMMs, EPROMS, EEPROMs, compact discs, DVDs, and/or the like. In accordance with some embodiments, memory 205 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information that can be used as memory 205. In some example aspects, memory 205 may store at least one database containing network information (e.g., ledgers, private/public keys, etc.).

Blockchain module 215 provides blockchain functionality for the system. The blockchain module 215 allows for the creation of a new block for a new/existing blockchain distributed ledger, hashing of the new block, and addition of the new block to the user's private blockchain and distributed ledger. Examples of hash functions include different types of Secure Hash Algorithms (SHA-1, SHA-2, or SHA-3) or a Jenkins hash function. The blockchain module 215 can manage a plurality of public blockchains, private blockchains, and/or other distributed ledgers for users. In some implementations, the privacy of each user's blockchain(s) can be ensured because each user maintains an individual blockchain and/or ledger for the user's data. In other implementations, transactions include a public key that matches a private key associated with the user. In these implementations, while the transactions are added to a public ledger, details of the transactions can only be accessed when the private key is used, ensuring user data privacy.

Blockchain module 215 is further configured to add new blocks to the blockchain when a user provides information to the network, joins other users in group plan, subscribes for or purchases a product or service, refers (recruits) another user to buy a product or pay for a subscription, when a user changes companies that provide products or services, when a user unsubscribes from a product or service, or when a user sells a product or service to another user. These new user actions/subscriptions/purchases and/or devices may need to be recorded on a blockchain so future users participating in the decentralized system can successfully and accurately validate the user's newly acquired permissions.

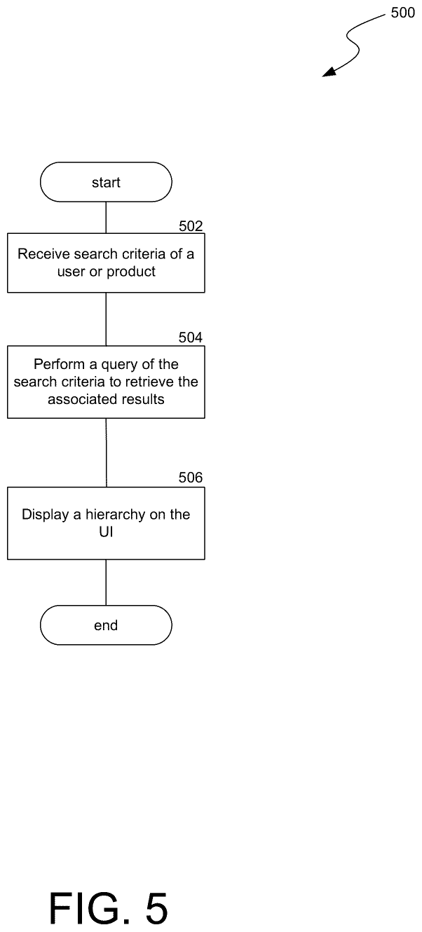

The hierarchy module 220 is configured to generate one or more hierarchies by collecting the user data (e.g., products or services, referred users, social network, companies providing the products or services, etc.) and arrange the user data, into an ordered set of nodes. The hierarchy module 220 can then iterate through levels of nodes, combining user data into combinations when the user data has similar matching features. As the hierarchy module 220 moves up creating levels of the hierarchy, each level requires fewer matching features to be combined until a root node is created (e.g., a node that cannot be combined with other nodes in the hierarchy). Additional details on memory hierarchies are provided below in relation to FIGS. 5-7.

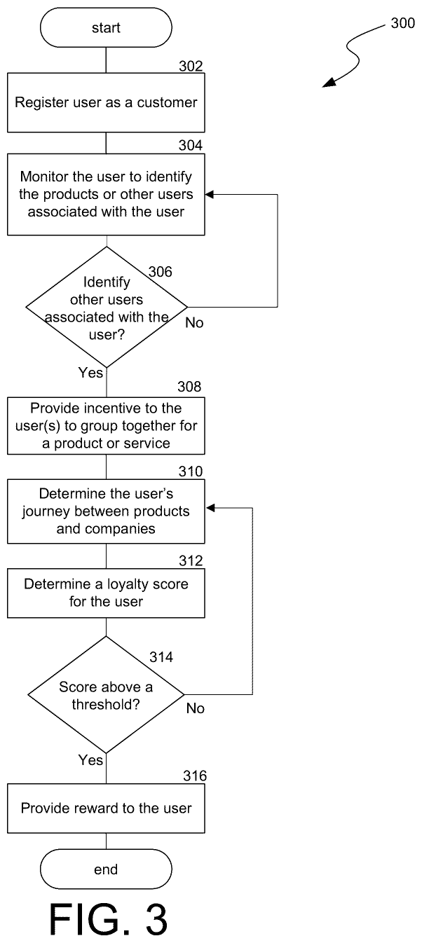

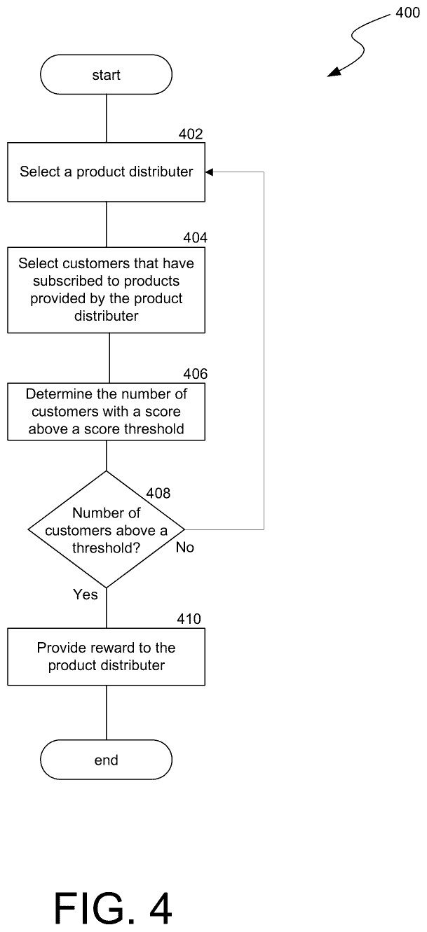

The incentive module 225 is configured to identify users to provide an incentive to. For example, the incentive module 225 provides an incentive (e.g., tokens, cryptocurrency, reduction in monthly bill, credit to apply to future bills, upgraded service packages, a share of stock, a coupon, a discount, an account credit, a statement credit, access to exclusive content, and an upgraded service package etc.) to a user who refers another user to subscribe to or purchase a product or service. Additional details on incentives are provided below in relation to FIGS. 3 and 4.

The user interface module 230 is configured to obtain, from a user interface, user search criteria. The user interface module 230 can receive input (e.g., customer name) from a search query and display the network of user connections, products or services, companies providing the products or services, and/or recruited users and their associated networks, in a hierarchy in a user interface.

Machine learning module 235 may be configured to track connections of a user and products or services of a user, to determine whether to provide an incentive to the user. The machine learning module 235 may be configured to monitor user activity based on at least one machine-learning algorithm trained on at least one dataset reflecting previously monitored user activity. The at least one machine-learning algorithms (and models) may be stored locally at databases and/or externally at databases (e.g., cloud databases and/or cloud servers). Client devices may be equipped to access these machine learning algorithms and intelligently analyze user data to identify whether to incentivize a user based on at least one machine learning model that is trained on a historical user data. For example, if a user recruits another user to subscribe for a product or service, the user data may be collected to train a machine learning model to automatically identify when a user subscribes for a product or service or recruits another user to subscribe, and provide an incentive to the user.

As described herein, a machine-learning (ML) model may refer to a predictive or statistical utility or program that may be used to determine a probability distribution over one or more character sequences, classes, objects, result sets or events, and/or to predict a response value from one or more predictors. A model may be based on, or incorporate, one or more rule sets, machine learning, a neural network, or the like. In examples, the ML models may be located on the client device, service device, a network appliance (e.g., a firewall, a router, etc.), or some combination thereof. The ML models may process network data and other data stores of user data to determine when to incentive a user based on the customer loyalty or recruiting other users. Based on an aggregation of data of user activity, network devices, and other user data stores, at least one ML model may be trained and subsequently deployed to automatically determine whether to provide an incentive to a user. The trained ML model may be deployed to one or more devices. As a specific example, an instance of a trained ML model may be deployed to a server device and to a client device. The ML model deployed to a server device may be configured to be used by the client device when, for example, the client device is connected to the Internet. Conversely, the ML model deployed to a client device may be configured to be used by the client device when, for example, the client device is not connected to the Internet. In some instances, a client device may not be connected to the Internet but still configured to receive satellite signals with network data. In such examples, the ML model may be locally cached by the client device. In some implementations, the machine learning module 235 identifies newly connected devices to the network and collect user data from the newly connected devices.

Communications module 240 is associated with sending/receiving information (e.g., network information, product or service information, user information, or device information from blockchain module 215, hierarchy module 220, incentive module 225, user interface module 230, and machine learning module 235) with a remote server or with one or more client devices, streaming devices, OTA boxes, set-top boxes, etc. These communications can employ any suitable type of technology, such as Bluetooth, Wi-Fi, WiMAX, cellular, single hop communication, multi-hop communication, Dedicated Short Range Communications (DSRC), or a proprietary communication protocol. Furthermore, communications module 240 may be configured to communicate network utilization and outage data to a client device and/or OTA box, smart OTA antenna, and/or smart TV, etc.

FIG. 3 is a flow diagram illustrating a process 300 used in some implementations for monitoring users on a decentralized network. In some implementations, process 300 is triggered by a user activating a subscription (e.g., subscription for a product or service), a device connecting to a decentralized network, a device connecting to a blockchain network, powering on a device, a device connecting to a gateway (e.g., router), or the user downloading an application on a device. In various implementations, process 300 is performed locally on the user device or performed by cloud-based device(s) that can support connecting to and/or participating in a decentralized network.

At block 302, process 300 registers a user as a member of a decentralized network. Process 300 can receive identification (e.g., IP address, MAC address, Universal Unique Identifier (UUID), global unique identifier (GUID), etc.) of the user device(s) that will connect to the decentralized network. The registration can include the user providing a list of products or services that the user has a subscription for and the company(s) that provides the products or services. In some cases, process 300 assigns a token to identify the user and/or user device. The registration can include a subscription (e.g., monthly fee, one time cost, etc.) for the system to monitor the user activity and provide incentives to the user.

Process 300 can detects a device that connects to the decentralized network. The device (e.g., set-top box, smart TV, tablet, laptop, smartphone, router, etc.) can be a gateway (node) in the decentralized network and can communicate with other devices. Process 300 can receive a token (e.g., personal access token) with an associated hash value from the device as part of the detection of the device, or the device can provide the token separately. In some implementations, process 300 identifies the token associated with the device when the device connects to the decentralized network. The token can identify the device, the associated user of the device, a user account, and/or the type of subscription of the user. The token can provide authorization that the user is permitted to participate in and receive rewards based on the user activity. In some implementations, process 300 performs randomized or periodic checks to identify devices connected to the network.

Each device in the decentralized network may be configured with a particular hash value that is comprised of a private and public key, as well as a hash algorithm (e.g., SHA 256). A hash value may be generated by hashing the private and public keys of the device with the hash algorithm. The hash value may be associated with the device (e.g., set-top box, laptop, etc.). The hash value may also be correlated with the user subscription, such as the system providing incentives or rewards to the user based on the user activity. The subscription and device details may be stored on a blockchain, where a central authority (e.g., the distributed computing provider) and/or other devices in the network (e.g., other set-top boxes, smart TVs, mobile devices, etc.) can view the hash value and the details associated with that hash value. When a device requests to participate in the system, the request, device information, and user subscription may be recorded in a subsequent block on the blockchain. To verify whether a device is permitted to participate in the system, a comparison must be performed between the permissions of the user stored in the ledger and the request. For example, based on the user permissions (e.g., based on a subscription package) associated with each device, when a device connects to the system, the device is first validated to ensure the user is permitted to access the products or services. If process 300 validates the request, the device may participate in the system. If process 300 does not validate the request, then the request will be denied, and the device will not be able to connect to the system.

In some example aspects, other devices (“verification devices”) in the decentralized network may perform this comparison. In some instances, the comparison may be in the form of a proof-of-coverage, proof-of-work, or proof-of-stake verification method. When a certain number of devices (e.g., 6) verify the requesting device's access to the system, the requesting device may be granted access. To incentivize the other devices in the network performing this verification step, the other devices may receive a reward/incentive (e.g., tokens, cryptocurrency, reduction in monthly bill, credit to apply to future bills, upgraded service packages, a share of stock, a coupon, a discount, an account credit, a statement credit, access to exclusive content, and an upgraded service package etc.) from the network and/or network provider. Once the device(s) is verified, process 300 can add the device to a whitelist so the distributed computing system can identify that the device is not a nefarious actor.

At block 304, process 300 monitors the user data associated with the user to identify the products (or service) that the user has a subscription for or has purchased. Process 300 can identify the companies that provide the products to the user. The user data can include the duration that the user has had a product and any other users that the user has interacted with or recruited/referred to purchase or subscribe to the product. In some implementations, process 300 monitors the user data based on input from a user interface (UI). For example, a username, a product, or company is entered in a UI.

Process 300 can monitor the user data to identify other users that the user has a relationship with or comes in contact with. Process 300 monitors location data of a user device to identify other users (e.g., family members, coworkers, teammates, etc.) that the user is within routine (e.g., daily, weekly, etc.) proximity of. For example, process 300 identifies other users that are coworkers, teammates on a sports team, volunteer at the same events, or any activity that the user is routinely within a proximity of the other users. Process 300 can analyze social media data to identify other users that are connected to the user. For example, the user can provide the system access to their social media accounts to identify connections of the user based on direct messages, blog posts, liked content, etc. Process 300 can analyze device data of user to identify contacts in a user's device. For example, process 300 identifies phone numbers that the user frequently (e.g., hourly, daily, weekly, etc.) messages or voice calls. Process 300 can rank the other users based the frequency that the user communicates with them and/or the amount of time the other users are within a proximity of the user.

Process 300 can determine a score associated with the relationship between the user and the other users. The score can be weighted according to the parameters (e.g., proximity data, contacts information on devices, social media, frequency of interaction, etc.) that associate the users together. In a first example, if the users share contact information on their devices, the score receives a higher weight than if the users follow each other on a social media application. In a second example, if the location data of the users indicates that the users are within a proximity regularly, such as hourly, daily, or weekly, the score receives a higher weight than if the users are within a proximity rarely, such as yearly. In a third example, if communication data indicates that the users communicate (e.g., voice calls or messaging) more than a threshold amount (e.g., 5 times or any amount) within a time threshold (e.g., day, week, or any amount of time), the score receives a higher weight than if the users communicate less than the threshold amount of times within the time threshold. Process 300 can generate sub scores for each parameter, such as a sub score for location data, a sub score for social media interaction, a sub score for sharing contact information, and a sub score for frequency of interactions. Process 300 can generate an overall score by combining all or some of the sub scores of the parameters.

At block 306, process 300 identifies whether there are other users associated with the user. For example, process 300 determines whether the user has referred other users (e.g., customers, family members, etc.) to subscribe to or purchase a product. If no users are identified as being associated with the user, process 300 continues to monitor for new products or services the user has subscribed to or purchased or other users that the user is associated with. Process 300 can identify other users that have a relationship score with the user above a threshold. If the relationship score is above a threshold, process 300 can provide the users with an opportunity to be grouped together to receive an incentive, such as a discount on a product or service fee/subscription.

If other users are identified as being associated with the user, at block 308, process 300 provides an incentive (e.g., tokens, cryptocurrency, reduction in monthly bill, credit to apply to future bills, upgraded service packages, a share of stock, a coupon, a discount, an account credit, a statement credit, access to exclusive content, and an upgraded service package etc.) to the user to be grouped together with the other identified users. Process 300 can adjust the incentive based on the number of users that are grouped together. In an example, process 300 can adjust the incentive based on the cost or volume of products that the referred user has purchased or subscribed to.

Due to the user data being stored on a decentralized network, at block 310, process 300 determines a user's journey of purchasing or subscribing to products or services over an amount of time (e.g., month, year, 5 years, lifetime, etc.). Process 300 can determine the duration that the user has had a subscription, or the duration that the user has maintained a current subscription for a product, and the company that provided the product. The user data can be validated on the decentralized network by other participants in the decentralized network.

At block 312, process 300 determines and assigns a loyalty score to the user based on the user's journey. Process 300 can score the user based on the length of time that the user maintains a subscription/product, how many other customers the user has referred, how many other users are grouped together with the user, or the length of time the user has been a customer of a particular company. Process 300 can generate sub scores for each parameter, such as a sub score for the length of time that the user maintains a subscription/product, a sub score for how many other customers the user has referred, a sub score for how many other users are grouped together with the user, and a sub score for the length of time the user has been a customer of a particular company. Process 300 can generate an overall loyalty score by combining all or some of the sub scores. Participants of the decentralized network can verify the loyalty score by accessing the user data stored on the decentralized network to ensure the accuracy of the length of time that the user maintained a subscription/product, how many other customers the user has referred, how many other users are grouped together with the user, or the length of time the user has been a customer of a particular company.

At block 314, process 300 determines whether the loyalty score is above a threshold value. If the loyalty score is not above the threshold value, process 300 continues to block 310. If the loyalty score is above the threshold value, at block 316, process 300 provides a reward/incentive (e.g., tokens, cryptocurrency, reduction in monthly bill, credit to apply to future bills, upgraded service packages, a share of stock, a coupon, a discount, an account credit, a statement credit, access to exclusive content, and an upgraded service package etc.) to the user based on the score.

By storing the customer information, contact data, and product data on a decentralized network, the system can track customers across any number of platforms, companies, products, or services. For example, the system can determine whether a customer is a loyal to a product or service but switched companies due to price or convenience. In some implementations, the customer can control the amount of information that is available for the system to access. Due to the user and company data being stored on the decentralized network, the system can verify if a sales employee of a company committed fraud by grouping customers into a group plan who were not associated with each other. For example, a company can identify if an employee committed fraud by grouping users together to reach sales quotas or any performance metrics. In a first example, users can be grouped together because of proximity location data, however a grouping error may result if those users never met or had any contact with each other. By using the decentralized network, the system can identify this error.

FIG. 4 is a flow diagram illustrating a process used in some implementations for monitoring a product distributer on a decentralized network. In some implementations, process 400 is triggered by a user activating a subscription (e.g., subscription for a product or service), a device connecting to a decentralized network, a device connecting to a blockchain network, powering on a device, a device connecting to a gateway (e.g., router), or the user downloading an application on a device. In various implementations, process 400 is performed locally on the user device or performed by cloud-based device(s) that can support connecting to and/or participating in a decentralized network.

At block 402, process 400 selects a product distributor (e.g., company, individual salesman, sales department, etc.) that provides a product (or service) to a user. Process 400 can select the product distributer randomly, periodically, or prior to a performance evaluation of the product distributer. Process 400 can retrieve characteristics associated with the product distributor, such as how long a customer retains their accounts, the products the customer's choose, product upgrades, etc., to determine the short term and long term performance of a product distributor.

At block 404, process 400 selects customers that have purchased or subscribed to products provided by the product distributer. Process 400 can search for customers based on a product distributer identifier (e.g., token, ID number, etc.) assigned to products provided by the product distributor.

At block 406, process 400 determines the number of customers that have a customer score above a score threshold value (e.g., the score described in blocks 312 and 314 of FIG. 3). The customer score can indicate the number of products the customer has a subscription for or has purchased, the length of time the customer has subscribed for a product, the length of time the customer has had a membership to a company, or the amount of money the customer has spent at the company.

At block 408, process 400 determines whether the number of selected customers exceeds a threshold value. If the number of selected customers does not exceed the threshold, process 400 can select a different product distributer (return to block 402). If the number of selected customers exceeds the threshold, at block 410, process 400 provides a reward/incentive to the product distributer. The reward can include a financial incentive (e.g., crypto currency, paid time off, money, etc.) for the product distributer. By storing the customer information on a decentralized network, the system can track a customer across any number of platforms, companies, products, or services. The system can accurately reward a product distributer who recruited a highly profitable customer, even if the customer has changed companies, if the customer switching companies was a result of factors other than the product distributer.

FIG. 5 is a flow diagram illustrating a process used in some implementations for generating a data hierarchy associated with a user. In some implementations, process 500 is triggered by a user activating a subscription (e.g., subscription for a product or service), a device connecting to a decentralized network, a device connecting to a blockchain network, powering on a device, a device connecting to a gateway (e.g., router), a device initiating a search for a user, product or service, or the user downloading an application on a device. In various implementations, process 500 is performed locally on the user device or performed by cloud-based device(s) that can support connecting to and/or participating in a decentralized network.

At block 502, process 500 receives search criteria of user, product, or service from a user interface (UI). At block 504, process 500 performs a query of the search criteria to retrieve results associated with the search criteria. Process 500 can query the decentralized network to identify information associated with the search criteria. For example, for a search criteria associated with a user, the system can retrieve the products or services the user has purchased or has a subscription for, the number of customers the user has recruited, the companies that provide the products or services, the product distributers associated with selling the products or services to the user, or similarly related information. At block 506, process 500 displays the results in a hierarchy or graph on the user interface.

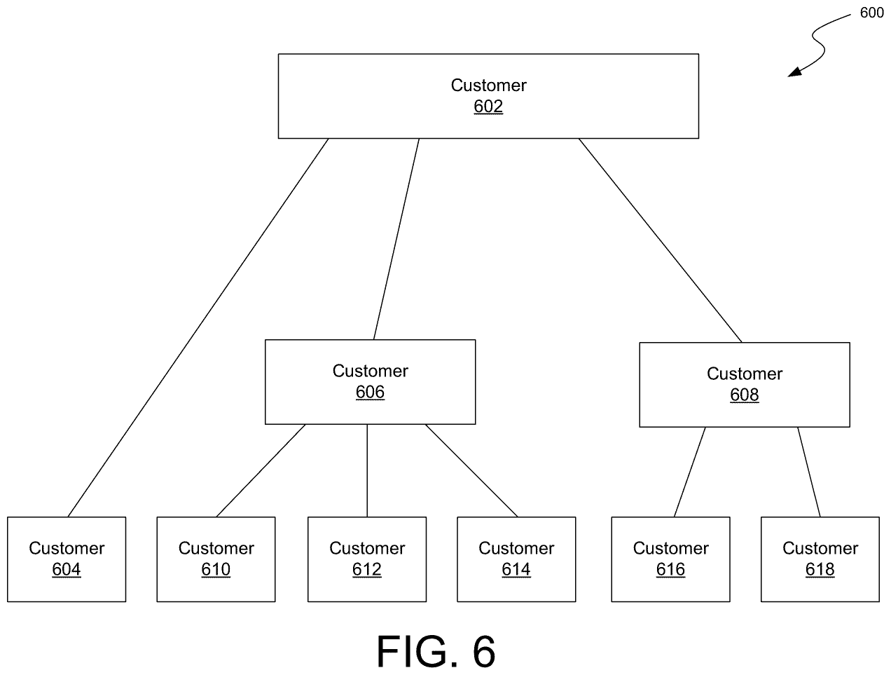

FIG. 6 is a conceptual diagram depicting the organization of multiple customers into a customer hierarchy 600. Customers 602, 604, 606, 608, 610, 612, 614, 616, and 618 are arranged into an ordered set of leaf nodes to illustrate the hierarchy of customers based on referrals. For example, customer 602 referred customers 604, 606, and 608. Customer 606 referred customers 610, 612, and 614. Customer 608 referred customers 616 and 618. As the originating customer, customer 602 can receive an incentive for all the lower-level leaf nodes that are added from customers 604, 606, and 608. Customer 606 can receive an incentive for all the lower-level leaf nodes that are added from customers 610, 612, and 614. Customer 608 can receive an incentive for all the lower-level leaf nodes that are added from customers 616 and 618.

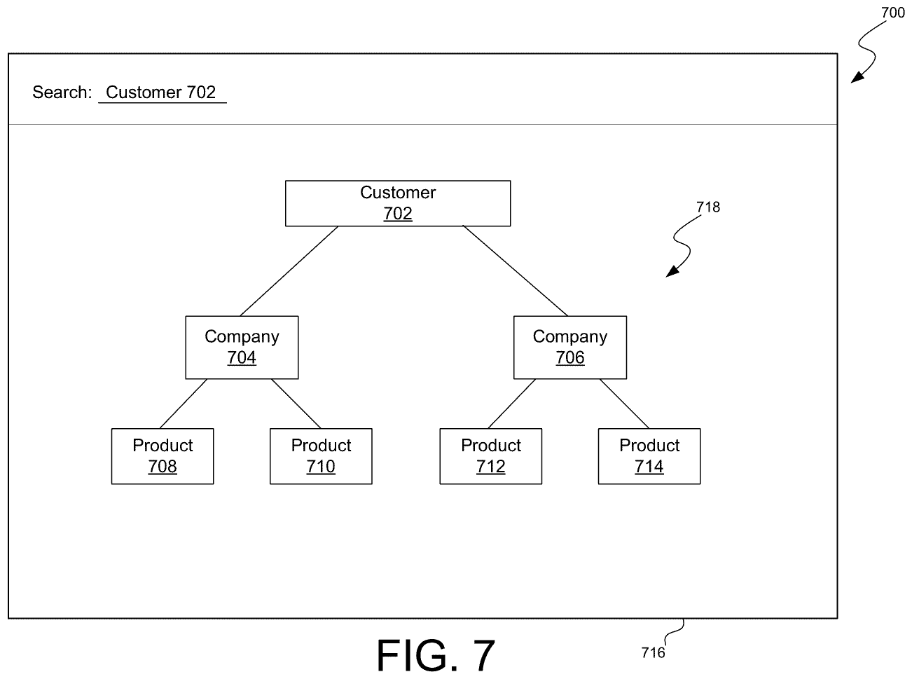

FIG. 7 is a conceptual diagram depicting an example 700 of browsing customers via a customer hierarchy and based on user search criteria. In example 700, the user has supplied a search criterion of “Customer 702” in user interface 716. Based on this search criteria, hierarchy 718 has been created. Hierarchy 718 illustrates that based the search criteria of customer 702, the system retrieves the companies (e.g., company 704 and 706) and the products (e.g., products 708, 710, 712, and 714) provided by the companies that the user has subscribed to or purchased. The system can display the results in the user interface 716 to provide a visualization of the companies and products that are associated with customer 702.

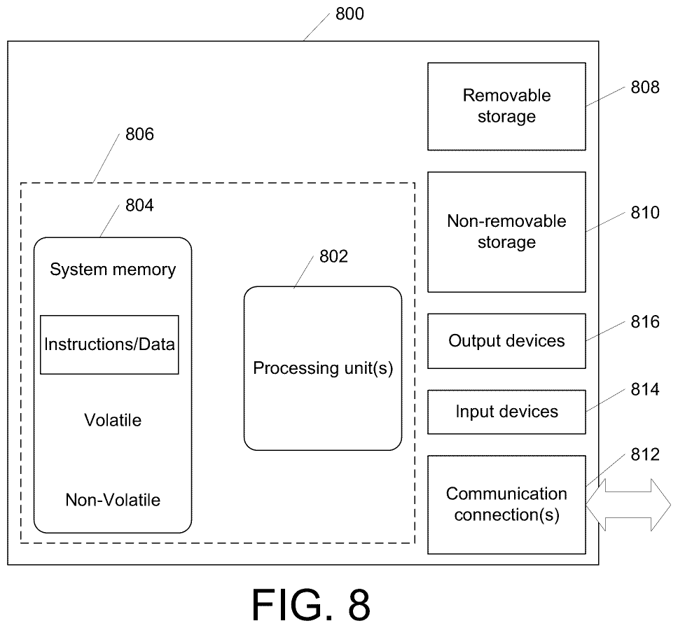

FIG. 8 illustrates one example of a suitable operating environment in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 800 typically includes at least one processing unit 802 and memory 804. Depending on the exact configuration and type of computing device, memory 804 (storing, among other things, information related to detected devices, compression artifacts, association information, personal gateway settings, and instruction to perform the methods disclosed herein) may be volatile (such as RAM), non-volatile (such as ROM, flash memory, etc.), or some combination of the two. This most basic configuration is illustrated in FIG. 8 by dashed line 806. Further, environment 800 may also include storage devices (removable 808 and/or non-removable 810) including, but not limited to, magnetic or optical disks or tape. Similarly, environment 800 may also have input device(s) 814 such as keyboard, mouse, pen, voice input, etc., and/or output device(s) 816 such as a display, speakers, printer, etc. Also included in the environment may be one or more communication connections, 812, such as Bluetooth, Wi-Fi, WiMAX, LAN, WAN, point to point, etc.

Operating environment 800 typically includes at least some form of computer readable media. Computer readable media can be any available media that can be accessed by processing unit 802 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM EEPROM, flash memory or other memory technology, CD-ROM, digital versatile disks (DVD) or other optical storage, magnetic cassettes, magnetic tape, magnetic disk storage, or other magnetic storage devices, or any other tangible medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulate data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The operating environment 800 may be a single computer (e.g., mobile computer) operating in a networked environment using logical connections to one or more remote computers. The remote computer may be a personal computer, a server, a router, a network PC, a peer device, an OTA antenna, a set-top box, or other common network node, and typically includes many or all of the elements described above as well as others not so mentioned. The logical connections may include any method supported by available communications media. Such networking environments are commonplace in offices, enterprise-wide computer networks, intranets, and the Internet.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of the claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and the alternate aspects falling within the spirit of the broader aspects of the general inventive concept embodied in this application that do not depart from the broader scope of the claimed disclosure.

From the foregoing, it will be appreciated that specific embodiments of the invention have been described herein for purposes of illustration, but that various modifications may be made without deviating from the scope of the invention. Accordingly, the invention is not limited except as by the appended claims.

What is claimed is:

1. A method for monitoring device activity on a blockchain network, the method comprising:
detecting a device connect to the blockchain network;
receiving, from the device, at least one token that authorizes the device to participate in a product tracking system;
receiving in a user interface a search query for location information associated with the device;
collecting the location information stored on the blockchain network, wherein the location information includes one or more devices that are within a proximity of the device;
determining a score for grouping the device and the one or more devices into a product plan based on an amount of time that the device and the one or more devices are within the proximity; and
in response to the score being above a threshold, providing at least one reward to an account associated with the device to join the one or more devices in the product plan.

2. The method of claim 1, further comprising:
generating a hierarchy of user information stored on the blockchain network, wherein the hierarchy illustrates two or more products provided by two or more companies; and
displaying the hierarchy on the user interface.

3. The method of claim 1, further comprising:
receiving in the user interface a second search query for a product distributor that supplies at least one product to the account associated with the device; and
in response to the score being above the threshold, providing at least a second reward to the product distributor.

4. The method of claim 1, further comprising:
determining a first user associated with the device referred a second user to subscribe to at least one product; and
providing at least a second reward to the first user.

5. The method of claim 1, wherein providing the at least one reward is recorded as a transaction on the blockchain network.

6. The method of claim 1, wherein the location information is analyzed and the at least one reward is determined by at least one machine-learning algorithm, wherein the at least one machine-learning algorithm is trained based on at least one dataset associated with previously analyzed location information and determined rewards.

7. The method of claim 1, wherein the at least one reward is at least one of: a cryptocurrency, a share of stock, a coupon, a discount, an account credit, a statement credit, access to exclusive content, and an upgraded service package.

8. A system comprising:
one or more processors; and
one or more memories storing instructions that, when executed by the one or more processors, cause the system to perform a process for monitoring device activity on a blockchain network, the process comprising:
detecting a device connect to the blockchain network;
receiving, from the device, at least one token that authorizes the device to participate in a product tracking system;
receiving in a user interface a search query for location information associated with the device;
collecting the location information stored on the blockchain network, wherein the location information includes one or more devices that are within a proximity of the device;
determining a score for grouping the device and the one or more devices into a product plan based on an amount of time that the device and the one or more devices are within the proximity; and
in response to the score being above a threshold, providing at least one reward to an account associated with the device to join the one or more devices in the product plan.

9. The system according to claim 8, wherein the process further comprises:
generating a hierarchy of user information stored on the blockchain network, wherein the hierarchy illustrates two or more products provided by two or more companies; and
displaying the hierarchy on the user interface.

10. The system according to claim 8, wherein the process further comprises:
receiving in the user interface a second search query for a product distributor that supplies at least one product to the account associated with the device; and
in response to the score being above the threshold, providing at least a second reward to the product distributor.

11. The system according to claim 8, wherein the process further comprises:
determining a first user associated with the device referred a second user to subscribe to at least one product; and
providing at least a second reward to the first user.

12. The system according to claim 8, wherein providing the at least one reward is recorded as a transaction on the blockchain network.

13. The system according to claim 8, wherein the location information is analyzed and the at least one reward is determined by at least one machine-learning algorithm, wherein the at least one machine-learning algorithm is trained based on at least one dataset associated with previously analyzed location information and determined rewards.

14. The system according to claim 8, wherein the at least one reward is at least one of: a cryptocurrency, a share of stock, a coupon, a discount, an account credit, a statement credit, access to exclusive content, and an upgraded service package.

15. A non-transitory computer-readable medium storing instructions that, when executed by a computing system, cause the computing system to perform operations for monitoring device activity on a blockchain network, the operations comprising:
detecting a device connect to the blockchain network;
receiving, from the device, at least one token that authorizes the device to participate in a product tracking system;
receiving in a user interface a search query for location information associated with the device;
collecting the location information stored on the blockchain network, wherein the location information includes one or more devices that are within a proximity of the device;
determining a score for grouping the device and the one or more devices into a product plan based on an amount of time that the device and the one or more devices are within the proximity; and
in response to the score being above a threshold, providing at least one reward to an account associated with the device to join the one or more devices in the product plan.

16. The non-transitory computer-readable medium of claim 15, wherein the operations further comprise:
generating a hierarchy of user information stored on the blockchain network, wherein the hierarchy illustrates two or more products provided by two or more companies; and
displaying the hierarchy on the user interface.

17. The non-transitory computer-readable medium of claim 15, wherein the operations further comprise:
receiving in the user interface a second search query for a product distributor that supplies at least one product to the account associated with the device; and
in response to the score being above the threshold, providing at least a second reward to the product distributor.

18. The non-transitory computer-readable medium of claim 15, wherein the operations further comprise:
determining a first user associated with the device referred a second user to subscribe to at least one product; and
providing at least a second reward to the first user.

19. The non-transitory computer-readable medium of claim 15, wherein the location information is analyzed and the at least one reward is determined by at least one machine-learning algorithm, wherein the at least one machine-learning algorithm is trained based on at least one dataset associated with previously analyzed location information and determined rewards.

20. The non-transitory computer-readable medium of claim 15, wherein the at least one reward is at least one of: a cryptocurrency, a share of stock, a coupon, a discount, an account credit, a statement credit, access to exclusive content, and an upgraded service package.
